(19) United States
(12) Patent Application Publication
(10) Pub. No.: US 2010/0033648 A1
(43) Pub. Date: Feb. 11, 2010

(54) Liquid Crystal Display Device

(75) Inventor: Nobuyuki KAGANEZAWA, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/536,632

(22) Filed: Aug. 6, 2009

(30) Foreign Application Priority Data
Aug. 8, 2008 (JP) 2008-205790

(51) Int. Cl. G02F 1/1333

(52) U.S. Cl. 349/58

(57) ABSTRACT

A liquid crystal display device includes: a liquid crystal panel which includes a liquid crystal layer and a pair of resilient substrates which sandwiches the liquid crystal layer therebetween; and a curving holding means (a lower frame, an upper frame, a plurality of bolts, and a plurality of nuts) which clamps an outer peripheral portion of the liquid crystal panel from a front surface and a back surface of the liquid crystal panel so as to hold the liquid crystal panel in a state that the liquid crystal panel is curved in one direction, wherein a clamping force applied to a non-curved outer peripheral portion of the liquid crystal panel by the curving holding means is set larger than a clamping force applied to a curved outer peripheral portion of the liquid crystal panel by the curving holding means.

The present application claims priority from Japanese applications JP 2008-205790 filed on Aug. 8, 2008, the content of which is hereby incorporated by reference into this application.

### BACKGROUND OF THE INVENTION

1. Field of the Invention

The present invention relates to a liquid crystal display device, and more particularly to a liquid crystal display device which includes a curved liquid crystal panel.

2. Description of the Related Art

In the manufacture of a curved-face display using a liquid crystal panel, it is advantageous to adopt the following method for relatively easily manufacturing the curved-face display. That is, a liquid crystal panel having resiliency by making thicknesses of a pair of transparent substrates (for example, glass substrates) which sandwiches a liquid crystal layer therebetween small is prepared. Then, the liquid crystal panel is curved in one direction along a suitable curved member and, at the same time, sides of the liquid crystal panel which are not curved (non-curved sides) and are arranged orthogonal to sides of the liquid crystal panel which are curved (curved sides) are held by a holding member. For example, JP-A-8-286174 (patent document 1) and JP-A-2006-106079 (patent document 2) disclose a technique for curving the liquid crystal panel.

### SUMMARY OF THE INVENTION

However, when a liquid crystal panel is curved in one direction by the above-mentioned method, as shown in FIG. 7, due to elasticity of a transparent substrate (a force which acts to return the transparent substrate to an original shape), a gap between the substrates is increased in a zone 70 in the vicinity of the center of a non-curved side 60 which is not directly held by a curving member not shown in the drawing thus giving rise to a drawback that display irregularities (so-called gap irregularities) occur in the zone 70 in the vicinity of the center of the non-curved side 60.

The invention has been made under such circumstances, and it is an object of the invention to provide a liquid crystal display device which can decrease display irregularities attributed to curving of a liquid crystal panel.

To overcome the above-mentioned drawbacks, according to one aspect of the invention, there is provided a liquid crystal display device which includes a liquid crystal panel which includes a liquid crystal layer and a pair of resilient substrates which sandwiches the liquid crystal layer therebetween, and a curving holding means which clamps an outer peripheral portion of the liquid crystal panel from a front surface and a back surface of the liquid crystal panel so as to hold the liquid crystal panel in a state that the liquid crystal panel is curved in one direction, wherein a clamping force applied to a non-curved outer peripheral portion of the liquid crystal panel by the curving holding means is set larger than a clamping force applied to a curved outer peripheral portion of the liquid crystal panel by the curving holding means.

According to the invention, it is possible to suppress the increase of a gap between the substrates at the non-curved outer peripheral portions of the liquid crystal panel curved in one direction. Since the increase of the gap between the substrates can be suppressed in this manner, it is possible to decrease display irregularities attributed to curving of the liquid crystal panel.

Further, according to one mode of the invention, the clamping force applied to the non-curved outer peripheral portion of the liquid crystal panel by the curving holding means differs corresponding to a distance from the curved outer peripheral portion of the liquid crystal panel.

Further, according to one mode of the invention, the clamping force applied to the non-curved outer peripheral portion of the liquid crystal panel by the curving holding means is increased corresponding to the increase of the distance from the curved outer peripheral portion of the liquid crystal panel. According to the mode, it is possible to preferably suppress the increase of the gap between the substrates in the vicinity of the center of the non-curved outer peripheral portion of the liquid crystal panel curved in one direction.

Further, according to one mode of the invention, the curving holding means includes a front-surface-side curved frame which pushes an outer peripheral portion of the liquid crystal panel from a front surface side of the liquid crystal panel and a back-surface-side curved structural body which pushes at least the outer peripheral portion of the liquid crystal panel from a back surface side of the liquid crystal panel.

Further, according to one mode of the invention, the curving holding means further includes a plurality of fixing jigs which fixes a portion of the front-surface-side curved frame which faces the non-curved outer peripheral portion of the liquid crystal panel in an opposed manner and a portion of the back-surface-side curved structural body which faces the non-curved outer peripheral portion of the liquid crystal panel in an opposed manner in a state that both the portion of the front-surface-side curved frame and the portion of the back-surface-side curved structural body face each other.

Further, according to one mode of the invention, an interval between the fixing jigs is decreased corresponding to the increase of the distance from the curved outer peripheral portion of the liquid crystal panel.

Further, according to one mode of the invention, the fixing jig is a bolt and a nut which forms a pair.

In the mode, the bolts and the nuts may fix the front-surface-side curved frame and the back-surface-side curved structural body to each other in an opposed manner by way of a push plate having a predetermined thickness.

Further, according to one mode of the invention, the fixing jig is a removal preventing pawl which is joined to or integrally formed with one of the front-surface-side curved frame and the back-surface-side curved structural body, and is fitted into a predetermined portion of another of the front-surface-side curved frame and the back-surface-side curved structural body.

In the mode, a length of the removal preventing pawl may be increased corresponding to the increase of the distance from the curved outer peripheral portion of the liquid crystal panel.

Further, according to one mode of the invention, a portion of the front-surface-side curved frame which faces the non-curved outer peripheral portion of the liquid crystal panel in an opposed manner includes a raised portion which is raised corresponding to the distance from the curved outer peripheral portion of the liquid crystal panel.

Further, according to one mode of the invention, the back-surface-side curved structural body is a back-surface curved frame which pushes the outer peripheral portion of the liquid crystal panel from a back surface side of the liquid crystal panel.

In the mode, a portion of the back-surface curved frame which faces the non-curved outer peripheral portion of the liquid crystal panel in an opposed manner may include a raised portion which is raised corresponding to the distance from the curved outer peripheral portion of the liquid crystal panel.

Further, according to one mode of the invention, the back-surface-side curved structural body is arranged between the liquid crystal panel and a backlight which is arranged on a back surface side of the liquid crystal panel, and diffuses light emitted toward the liquid crystal panel from the backlight.

### BRIEF DESCRIPTION OF THE DRAWINGS

FIG. 1A and FIG. 1B are views showing constitutional parts of a liquid crystal display device according to an embodiment 1 of the invention;

FIG. 2 is a view showing constitutional parts of a liquid crystal display device according to an embodiment 2 of the invention;

FIG. 3 is a view showing constitutional parts of a liquid crystal display device according to an embodiment 3 of the invention;

FIG. 4 is a view showing an upper frame in which a plurality of removal preventing pawls is joined to or integrally formed with a non-curved edge portion;

FIG. 5 is a view showing the upper frame in which the vicinity of the center of the non-curved edge portion is raised;

FIG. 6A and FIG. 6B are cross-sectional views of a portion in the vicinity of a non-curved outer peripheral portion of a liquid crystal panel; and

FIG. 7 is a view showing a liquid crystal panel curved in one direction.

### DESCRIPTION OF THE PREFERRED EMBODIMENTS

Hereinafter, embodiments of the invention are explained in detail in conjunction with drawings. Here, the repeated explanation of identical or similar constitutional parts is omitted.

### Embodiment 1

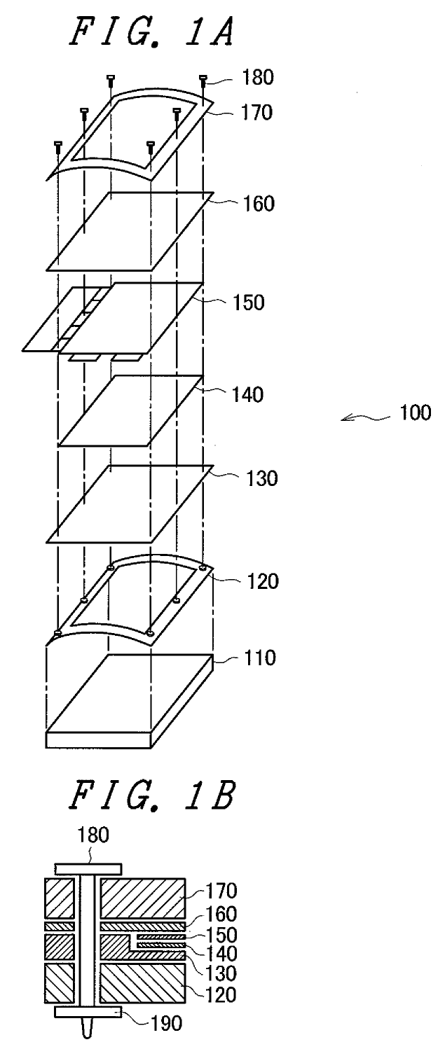

FIG. 1A and FIG. 1B are views showing constitutional parts of a liquid crystal display device 100 according to an embodiment 1 of the invention.

As shown in the drawing, the liquid crystal display device 100 includes a backlight 110, a lower frame 120, PC sheets (polycarbonate sheets) 130, 160, a diffusion sheet 140, a liquid crystal panel 150, an upper frame 170, bolts 180 and nuts 190.

The liquid crystal panel 150 includes a liquid crystal layer and a pair of quadrangular glass substrates having resiliency which sandwiches the liquid crystal layer therebetween. To the liquid crystal panel 150, a drive circuit for controlling voltages applied between pixel electrodes formed on one of the pair of glass substrates and counter electrodes formed on another of the pair of glass substrates, a flexible printed circuit board for transmitting electrical signals and the like to the drive circuit and the like are connected.

The backlight 110 is a light source which is arranged on a back surface side of the liquid crystal panel 150.

The diffusion sheet 140 is formed of a transparent or a semi-transparent sheet having resiliency and is arranged between the backlight 110 and the liquid crystal panel 150. The diffusion sheet 140 diffuses light emitted toward the liquid crystal panel 150 from the backlight 110.

The PC sheets 130, 160 are formed of a transparent sheet made of polycarbonate which has resiliency. The PC sheet 130 is arranged between the backlight 110 and the diffusion sheet 140, while the PC sheet 160 is arranged on a front surface side of the liquid crystal panel 150.

The lower frame 120, the upper frame 170, a plurality of bolts 180 and a plurality of nuts 190 constitute a curving holding means. That is, the curving holding means clamps an outer peripheral portion (a peripheral portion excluding a pixel region) of the quadrangular liquid crystal panel 150 from a front surface and a back surface of the liquid crystal panel 150 in such a manner that the liquid crystal panel 150 is held in a curved state (in an arcuate shape in this embodiment) in one direction.

The lower frame 120 is a metal-made frame which is arranged on aback surface side of the liquid crystal panel 150 and between the backlight 110 and the diffusion sheet 140. The lower frame 120 is constituted of a pair of opposedly-arranged edge portions which is curved in an arcuate shape so as to project toward the liquid crystal panel 150 side (hereinafter referred to as “curved edge portions”) and a pair of opposedly-arranged edge portions which is not curved (hereinafter referred to as “non-curved edge portions”). The lower frame 120 pushes the outer peripheral portion of the liquid crystal panel 150 from a back surface side of the liquid crystal panel 150 by way of the PC sheet 130 and the diffusion sheet 140. An opening region surrounded by the curved edge portions and the non-curved edge portions of the lower frame 120 corresponds to the pixel region of the liquid crystal panel 150 so that light emitted toward the liquid crystal panel 150 from the backlight 110 is not interrupted by the lower frame 120.

The upper frame 170 is a metal-made frame which is arranged on a front surface side of the liquid crystal panel 150. The upper frame 170 is constituted of a pair of opposedly-arranged curved edge portions which is curved in an arcuate shape so as to be recessed on the liquid crystal panel 150 side and a pair of opposedly-arranged non-curved edge portions which is not curved. The upper frame 170 pushes the outer peripheral portion of the liquid crystal panel 150 from a front surface side of the liquid crystal panel 150 by way of the PC sheet 160. An opening region surrounded by the curved edge portions and the non-curved edge portions of the upper frame 170 corresponds to the pixel region of the liquid crystal panel 150 so that light emitted toward the front surface side of the liquid crystal panel 150 from the liquid crystal panel 150 is not interrupted by the upper frame 170. Here, a curved shape of the curved edge portion of the upper frame 170 corresponds to a curved shape of the curved edge portion of the lower frame 120.

In the liquid crystal display device 100, as shown in FIG. 1A, the PC sheet 130, the diffusion sheet 140, the liquid crystal panel 150 and the PC sheet 160 are stacked in this order. Then, these constitutional parts are clamped between the lower frame 120 and the upper frame 170 from both upper and lower sides so that these constitutional parts are held in an arcuately curved state along the curved edge portions of the lower frame 120 and the curved edge portions of the upper frame 170.

Particularly, in this embodiment, a plurality of bolt insertion holes are formed in the non-curved edge portions of the upper frame 170, the non-curved edge portions of the lower frame 120, and the PC sheets 130, 160 which are clamped between the upper frame 170 and the lower frame 120 at predetermined intervals. As shown in FIG. 1B, the non-curved edge portions of the upper frame 170 and the non-curved edge portions of the lower frame 120 are fixed to each other in an opposedly facing manner by means of the bolts 180 which penetrate the bolt insertion holes and the nuts 190.

Due to such a constitution, a clamping force applied to the non-curved portions of the outer peripheral portion of the liquid crystal panel 150 (herein after referred to as “non-curved outer peripheral portions) by the curving holding means (the lower frame 120, the upper frame 170, the plurality of bolts 180 and the plurality of nuts 190) becomes larger than a clamping force applied to the curved portions of the outer peripheral portion of the liquid crystal panel 150 (hereinafter referred to as “curved outer peripheral portions). Accordingly, it is possible to suppress the increase of a gap between the substrates at the non-curved outer peripheral portions of the liquid crystal panel 150 having an arcuately curved shape. Since the increase of the gap between the substrates can be suppressed in this manner, it is possible to decrease display irregularities attributed to curving of the liquid crystal panel 150.

Here, the interval between the bolts 180 which fix the non-curved edge portions of the upper frame 170 and the non-curved edge portions of the lower frame 120 in an opposedly facing manner may be decreased corresponding to a distance from the curved outer peripheral portion of the liquid crystal panel 150. That is, the bolts 180 may be arranged more densely in the vicinity of the center of the non-curved edge portion of the upper frame 170 and in the vicinity of the center of the non-curved edge portion of the lower frame 120. Due to such a constitution, a portion of the non-curved edge portion of the arcuately curved liquid crystal panel 150 in the vicinity of the center of the non-curved edge portion is more firmly clamped than end portions of the non-curved edge portion of the arcuately curved liquid crystal panel 150 and hence, the increase of the gap between the substrates in the vicinity of the center of the non-curved edge portion of the liquid crystal panel 150 can be preferably suppressed.

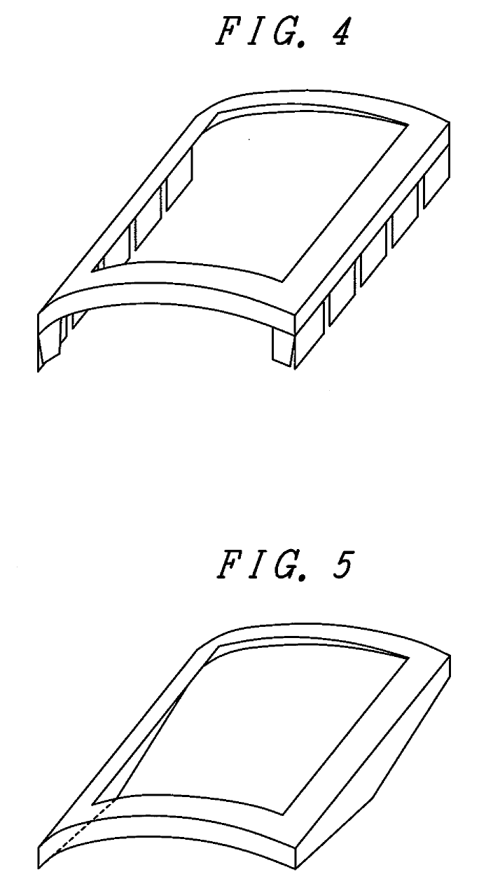

Further, as shown in FIG. 4, the non-curved edge portions of the upper frame 170 and the non-curved edge portions of the lower frame 120 maybe fixed to each other in an opposedly facing manner such that a plurality of removal preventing pawls is joined to or integrally formed with the non-curved edge portions of the upper frame 170, and these removal preventing pawls may be fitted into predetermined portions of the lower frame 120. Due to such a constitution, it is possible to clamp the non-curved edge portions of the liquid crystal panel 150 more firmly than the curved outer peripheral portions of the liquid crystal panel 150 without using the bolts 180 and the nuts 190. It is needless to say that these removal preventing pawls may be formed on a lower frame 120 side.

In this case, corresponding to a distance from the curved outer peripheral portion of the liquid crystal panel 150, the interval between the removal preventing pawls which fix the non-curved edge portion of the upper frame 170 and the non-curved edge portion of the lower frame 120 in an opposed facing manner may be decreased. Alternatively, corresponding to a distance from the curved outer peripheral portion of the liquid crystal panel 150, a length of the removal preventing pawl may be increased. Due to such a constitution, the increase of the gap between the substrates in the vicinity of the center of the non-curved edge portion of the arcuately curved liquid crystal panel 150 can be preferably suppressed.

Further, as shown in FIG. 5, a raised portion may be formed on the non-curved edge portion of the upper frame 170 in such a manner that the raised portion is raised corresponding to a distance from the curved outer peripheral potion of the liquid crystal panel 150. Also due to such a constitution, the increase of the gap between the substrates in the vicinity of the center of the non-curved edge portion of the arcuately curved liquid crystal panel 150 can be preferably suppressed.

### Embodiment 2

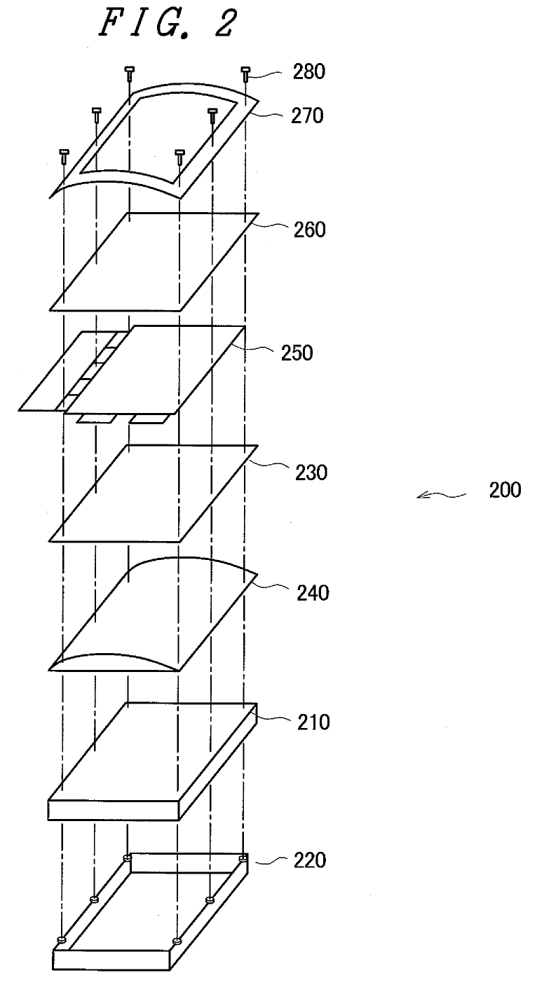

FIG. 2 is a view showing constitutional parts of a liquid crystal display device 200 according to an embodiment 2 of the invention.

As shown in the drawing, the liquid crystal display device 200 includes a lower frame 220, a backlight 210, a diffusion plate 240, a PC sheet 230, a liquid crystal panel 250, a PC sheet 260, an upper frame 270, bolts 280 and nuts (not shown in the drawing).

The liquid crystal panel 250 includes a liquid crystal layer and a pair of quadrangular glass substrates having resiliency which sandwiches the liquid crystal layer therebetween.

The backlight 210 is a light source which is arranged on a back surface side of the liquid crystal panel 250. The backlight 210 has a back surface side thereof supported by the lower frame 220.

The PC sheets 230, 260 are formed of a transparent sheet made of polycarbonate which has resiliency. The PC sheet 230 is arranged on a back surface side of the liquid crystal panel 250, while the PC sheet 260 is arranged on a front surface side of the liquid crystal panel 250.

The diffusion plate 240, the upper frame 270 and a plurality of bolts 280 and nuts constitute a curving holding means. That is, the curving holding means clamps an outer peripheral portion (a peripheral portion excluding a pixel region) of the quadrangular liquid crystal panel 250 from a front surface side and a back surface side in such a manner that the liquid crystal panel 250 is held in a curved state (in an arcuate shape in this embodiment) in one direction.

The diffusion plate 240 is formed of a transparent or a semi-transparent member which is arranged on a back surface side of the liquid crystal panel 250 and between the backlight 210 and the liquid crystal panel 250. The diffusion plate 240 diffuses light emitted toward the liquid crystal panel 250 from the backlight 210. Further, an upper surface of the diffusion plate 240 is formed into an arcuately curved surface which projects toward a liquid crystal panel 250 side. The upper surface of the diffusion plate 240 pushes the liquid crystal panel 250 from a back surface side of the liquid crystal display panel 250 by way of the PC sheet 230.

The upper frame 270 is a metal-made frame which is arranged on a front surface side of the liquid crystal panel 250. The upper frame 270 is constituted of a pair of opposedly-arranged curved edge portions which is curved in an arcuate shape so as to be recessed on the liquid crystal panel 250 side and a pair of opposedly-arranged non-curved edge portions which is not curved. The upper frame 270 pushes the outer peripheral portion of the liquid crystal panel 250 from a front surface side of the liquid crystal panel 250 by way of the PC sheet 260. An opening region surrounded by the curved edge portions and the non-curved edge portions of the upper frame 270 corresponds to the pixel region of the liquid crystal panel 250 so that light emitted toward the front surface side of the liquid crystal panel 250 from the liquid crystal panel 250 is not interrupted by the upper frame 270. Here, a curved shape of the curved edge portion of the upper frame 270 corresponds to a curved shape of the curved surface of the diffusion plate 240.

In the liquid crystal display device 200, as shown in FIG. 2, the backlight 210, the diffusion plate 240, the PC sheet 230, the liquid crystal panel 250 and the PC sheet 260 are stacked in this order. Then, these constitutional parts are clamped between the lower frame 220 and the upper frame 270 from both upper and lower sides. Out of these constitutional parts, the PC sheet 230, the liquid crystal panel 250 and the PC sheet 260 are held in an arcuately curved state along the curved surface of the diffusion plate 240 and the curved edge portions of the upper frame 270.

Particularly, in this embodiment, a plurality of bolt insertion holes is formed in the non-curved edge portions of the upper frame 270, and portions of the lower frame 220 which face the non-curved edge portions of the upper frame 270 (hereinafter referred to as “opposedly-facing fixing edge portions”) at predetermined intervals. The non-curved edge portions of the upper frame 270 and the opposedly-facing fixing edge portions of the lower frame 220 are fixed to each other in an opposedly facing manner by means of the bolts 280 which penetrate the bolt insertion holes and nuts. As a result, the non-curved edge portions of the upper frame 270 are also fixed to the diffusion plate 240 in an opposedly facing manner.

Due to such a constitution, a clamping force applied to the non-curved outer peripheral portions of the liquid crystal panel 250 by the curving holding means (the diffusion plate 240, the upper frame 270 and the plurality of bolts 280 and the plurality of nuts) becomes larger than a clamping force applied to the curved outer peripheral portions of the liquid crystal panel 250. Accordingly, it is possible to suppress the increase of a gap between the substrates at the non-curved outer peripheral portions of the liquid crystal panel 250 having an arcuately curved shape. Since the increase of the gap between the substrates can be suppressed in this manner, it is possible to decrease display irregularities attributed to curving of the liquid crystal panel 250.

Here, an interval between the bolts 280 which fix the non-curved edge portions of the upper frame 270 and the opposedly-facing fixing edge portions of the lower frame 220 in an opposedly facing manner may be decreased corresponding to the increased of a distance from the curved outer peripheral portion of the liquid crystal panel 250. That is, the bolts 280 may be arranged more densely in the vicinity of the center of the non-curved edge portion of the upper frame 270 and in the vicinity of the center of the non-curved edge portion of the lower frame 220. Due to such a constitution, the increase of the gap between the substrates in the vicinity of the center of the non-curved outer peripheral portion of the liquid crystal panel 250 having an arcuately curved shape can be preferably suppressed.

Further, in the same manner as the above-mentioned embodiment 1, a plurality of removal preventing pawls shown in FIG. 4 may be formed on the non-curved edge portions of the upper frame 270 or the raised portion shown in FIG. 5 may be formed on the non-curved edge portions of the upper frame 270 or portions of an upper surface of the diffusion plate 240 which face the non-curved edge portions of the upper frame 270 in an opposed manner.

### Embodiment 3

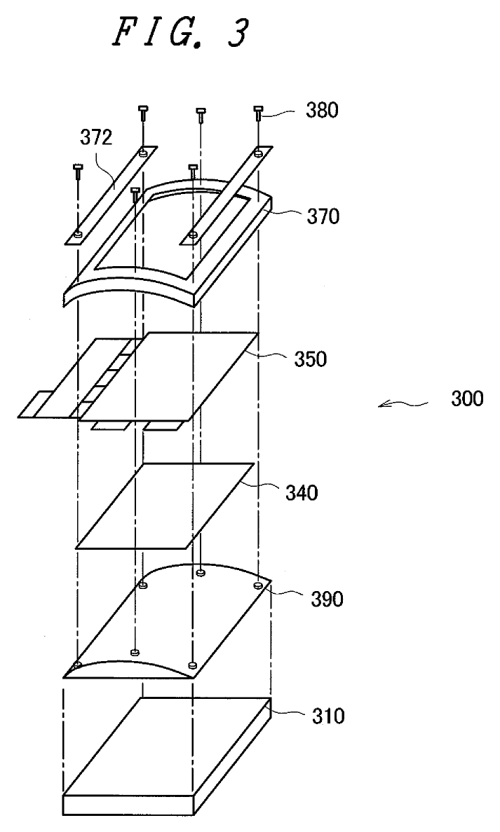

FIG. 3 is a view showing constitutional parts of a liquid crystal display device 300 according to an embodiment 3 of the invention.

As shown in the drawing, the liquid crystal display device 300 includes a backlight 310, a pipe 390, a diffusion sheet 340, a liquid crystal panel 350, an upper frame 370, push plates 372, bolts 380 and nuts (not shown in the drawing).

The liquid crystal panel 350 includes a liquid crystal layer and a pair of quadrangular glass substrates having resiliency which sandwiches the liquid crystal layer therebetween.

The backlight 310 is a light source which is arranged on a back surface side of the liquid crystal panel 350.

The diffusion sheet 340 is formed of a transparent or a semi-transparent sheet having resiliency and is arranged between the backlight 310 and the liquid crystal panel 350. The diffusion sheet 340 diffuses light emitted toward the liquid crystal panel 350 from the backlight 310.

The pipe 390, the upper frame 370, the push plates 372 and a plurality of bolts 380 and nuts constitute a curving holding means. That is, the curving holding means clamps an outer peripheral portion (a peripheral portion excluding a pixel region) of the quadrangular liquid crystal panel 350 from a front surface side and a back surface side in such a manner that the liquid crystal panel 350 is held in a curved state (in an arcuate shape in this embodiment) in one direction.

The pipe 390 is formed of a transparent member made of an acrylic resin, for example, which is arranged on a back surface side of the liquid crystal panel 350 and between the backlight 310 and the diffusion sheet 340. Further, an upper surface of the pipe 390 is formed into an arcuately curved surface which projects toward a liquid crystal panel 350 side. The upper surface of the pipe 390 pushes the liquid crystal panel 350 from a back surface side of the liquid crystal panel 350 by way of the diffusion sheet 340.

The upper frame 370 is a metal-made frame which is arranged on a front surface side of the liquid crystal panel 350. The upper frame 370 is constituted of a pair of opposedly-arranged curved edge portions which is curved in an arcuate shape so as to be recessed on the liquid crystal panel 350 side and a pair of opposedly-arranged non-curved edge portions which is not curved. The upper frame 370 pushes the outer peripheral portion of the liquid crystal panel 350 from a front surface side of the liquid crystal panel 350. An opening region surrounded by the curved edge portions and the non-curved edge portions of the upper frame 370 corresponds to the pixel region of the liquid crystal panel 350 so that light emitted toward the front surface side of the liquid crystal panel 350 from the liquid crystal panel 350 is not interrupted by the upper frame 370. Here, a curved shape of the curved edge portion of the upper frame 370 corresponds to a curved shape of the curved surface of the pipe 390.

In the liquid crystal display device 300, as shown in FIG. 3, the diffusion sheet 340 and the liquid crystal panel 350 are clamped by the pipe 390 and the upper frame 370 from both upper and lower sides so that the diffusion sheet 340 and the liquid crystal panel 350 are held in an arcuately curved state along the curved surface of the pipe 390 and the curved edge portions of the upper frame 370.

Particularly, in this embodiment, a plurality of bolt insertion holes is formed in the non-curved edge portions of the upper frame 370, and portions of the pipe 390 which face the non-curved edge portions of the upper frame 370 in an opposed manner (opposedly-facing fixing edge portions) at predetermined intervals. The non-curved edge portions of the upper frame 370 and the opposedly-facing fixing edge portions of the pipe 390 are fixed to each other in an opposedly facing manner by means of the bolts 380 which penetrate the bolt insertion holes and the nuts. Here, the bolts 380 and the nuts fix the upper frame 370 and the pipe 390 to each other in an opposedly facing manner by way of the push plates 372 having a predetermined thickness and in which bolt insertion holes are formed.

Due to such a constitution, a clamping force applied to the non-curved outer peripheral portions of the liquid crystal panel 350 by the curving holding means (the pipe 390, the upper frame 370, the push plates 372 and the plurality of bolts 380 and the plurality of nuts) becomes larger than a clamping force applied to the curved outer peripheral portions of the liquid crystal panel 350. Accordingly, it is possible to suppress the increase of a gap between the substrates at the non-curved outer peripheral portions of the liquid crystal panel 350 having an arcuately curved shape. Since the increase of the gap between the substrates can be suppressed in this manner, it is possible to decrease display irregularities attributed to curving of the liquid crystal panel 350.

According to the liquid crystal display devices 100, 200, 300 according to the embodiments 1, 2, 3 explained above, the increase of the gap between the substrates at the non-curved outer peripheral portion of the liquid crystal panel curved in one direction can be suppressed. Since the increase of the gap between the substrates can be suppressed in this manner, it is possible to decrease display irregularities attributed to curving of the liquid crystal panel.

The invention is not limited to the above-mentioned embodiments.

For example, in the above-mentioned embodiments, the example in which the quadrangular liquid crystal panel is curved is exemplified. However, the invention is also applicable to a liquid crystal panel having other shape such as a polygonal shape, a corner-rounded polygonal shape, or an elliptical shape. Further, the invention is not limited to the liquid crystal panel which is curved in an arcuate shape such that the liquid crystal panel projects toward a front surface side or is recessed on the front surface side, and is also broadly applicable to a liquid crystal panel which is curved in one direction (for example, a liquid crystal panel which is curved in a wave shape)

Further, kinds, the structures, the order of arrangement or the like of parts which constitute the liquid crystal display device may be suitably changed provided that it is possible to ensure the curving holding means which clamps the outer peripheral portion of the liquid crystal panel from the front surface and the back surface of the liquid crystal panel such that a state where the liquid crystal panel is curved in one direction is held.

Further, the curving holding means may be formed such that the upper frame, the lower frame and the like are integrally formed. In this case, the liquid crystal panel is slidably inserted into the curving holding means from a lateral side, for example.

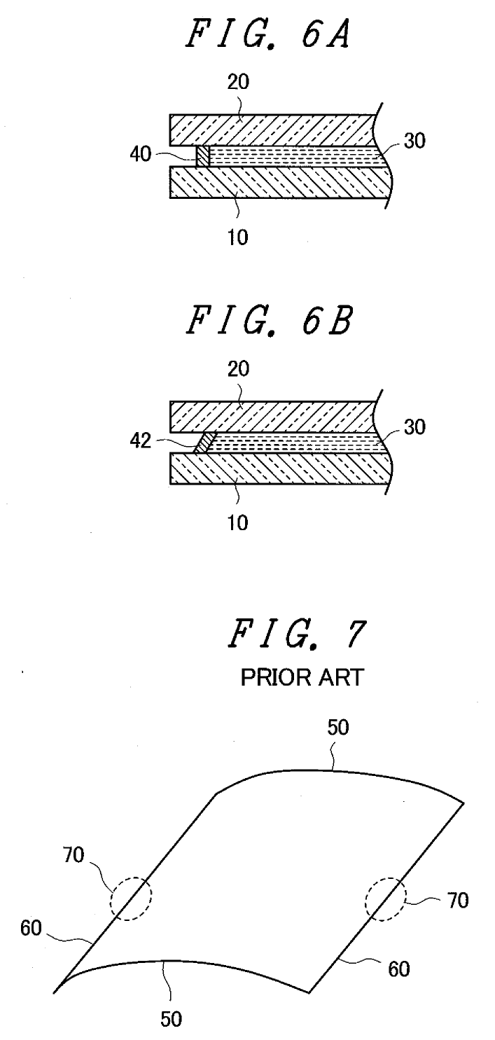

Here, to decrease display irregularities attributed to curving of the liquid crystal panel, the conventional structure for sealing the liquid crystal layer may be improved. FIG. 6A and FIG. 6B are partial cross-sectional views of a portion in the vicinity of the non-curved outer peripheral portion of the liquid crystal panel. Conventionally, as shown in FIG. 6A, a liquid crystal layer 30 is sealed in a space defined between a pair of opposedly-facing glass substrates 10, 20 by a sealing surface 40 which is arranged on edges of the glass substrate 10 and the glass substrate 20 perpendicular to a substrate surface. To the contrary, in the improved structure for sealing the liquid crystal layer, as shown in FIG. 6B, a sealing surface 42 which is inclined obliquely with respect to the substrate surface is formed on the edges of the glass substrates 10, 20. To be more specific, the sealing surface 42 is inclined such that an adhesion position between a glass substrate on a side where the glass substrate is elongated attributed to curving of the liquid crystal panel (here, glass substrate 10) and the sealing surface 42 is displaced from an adhesion position between a glass substrate on a side where the glass substrate is compressed (here, glass substrate 20) and the sealing surface 42 by a predetermined length in the direction toward the periphery of the substrate. Due to such a constitution, when the liquid crystal panel is curved, “a force which increases a gap between the substrates” generated on the glass substrate on the side where the glass substrate is elongated is decreased so that the display irregularities attributed to curving of the liquid crystal panel can be decreased.

What is claimed is:

1. A liquid crystal display device comprising:
a liquid crystal panel which includes a liquid crystal layer and a pair of resilient substrates which sandwiches the liquid crystal layer therebetween; and
a curving holding means which clamps an outer peripheral portion of the liquid crystal panel from a front surface and a back surface of the liquid crystal panel so as to hold the liquid crystal panel in a state that the liquid crystal panel is curved in one direction, wherein
a clamping force applied to a non-curved outer peripheral portion of the liquid crystal panel by the curving holding means is set larger than a clamping force applied to a curved outer peripheral portion of the liquid crystal panel by the curving holding means.

2. A liquid crystal display device according to claim 1, wherein the clamping force applied to the non-curved outer peripheral portion of the liquid crystal panel by the curving holding means differs corresponding to a distance from the curved outer peripheral portion of the liquid crystal panel.

3. A liquid crystal display device according to claim 2, wherein the clamping force applied to the non-curved outer peripheral portion of the liquid crystal panel by the curving holding means is increased corresponding to the increase of the distance from the curved outer peripheral portion of the liquid crystal panel.

4. A liquid crystal display device according to claim 1, wherein the curving holding means includes: a front-surface-side curved frame which pushes an outer peripheral portion of the liquid crystal panel from a front surface side of the liquid crystal panel; and a back-surface-side curved structural body which pushes at least the outer peripheral portion of the liquid crystal panel from a back surface side of the liquid crystal panel.

5. A liquid crystal display device according to claim 4, wherein the curving holding means further includes a plurality of fixing jigs which fixes a portion of the front-surface-side curved frame which faces the non-curved outer peripheral portion of the liquid crystal panel in an opposed manner and a portion of the back-surface-side curved structural body which faces the non-curved outer peripheral portion of the liquid crystal panel in an opposed manner in a state that both the portion of the front-surface-side curved frame and the portion of the back-surface-side curved structural body face each other.

6. A liquid crystal display device according to claim 5, wherein an interval between the fixing jigs is decreased corresponding to the increase of the distance from the curved outer peripheral portion of the liquid crystal panel.

7. A liquid crystal display device according to claim 5, wherein the fixing jig is a bolt and a nut which forms a pair.

8. A liquid crystal display device according to claim 7, wherein the bolt and the nut fix the front-surface-side curved frame and the back-surface-side curved structural body in an opposedly facing manner by way of a push plate having a predetermined thickness.

9. A liquid crystal display device according to claim 5, wherein the fixing jig is a removal preventing pawl which is joined to or integrally formed with one of the front-surface-side curved frame and the back-surface-side curved structural body, and is fitted into a predetermined portion of another of the front-surface-side curved frame and the back-surface-side curved structural body.

10. A liquid crystal display device according to claim 9, wherein a length of the removal preventing pawl is increased corresponding to the increase of the distance from the curved outer peripheral portion of the liquid crystal panel.

11. A liquid crystal display device according to claim 4, wherein a portion of the front-surface-side curved frame which faces the non-curved outer peripheral portion of the liquid crystal panel in an opposed manner includes a raised portion which is raised corresponding to the distance from the curved outer peripheral portion of the liquid crystal panel.

12. A liquid crystal display device according to claim 4, wherein the back-surface-side curved structural body is a back-surface curved frame which pushes the outer peripheral portion of the liquid crystal panel from a back surface side of the liquid crystal panel.

13. A liquid crystal display device according to claim 11, wherein a portion of the back-surface curved frame which faces the non-curved outer peripheral portion of the liquid crystal panel in an opposed manner includes a raised portion which is raised corresponding to the distance from the curved outer peripheral portion of the liquid crystal panel.

14. A liquid crystal display device according to claim 4, wherein the back-surface-side curved structural body is arranged between the liquid crystal panel and a backlight which is arranged on a back surface side of the liquid crystal panel, and diffuses light emitted toward the liquid crystal panel from the backlight.
